(19) United States
(12) Patent Application Publication
(10) Pub. No.: US 2016/0303568 A1
(43) Pub. Date: Oct. 20, 2016

(54) METHOD AND DEVICE FOR PLACEMENT OF MICROSCOPIC SAMPLE INTO THE TUBE.

(71) Applicant: Dmitri Dozortsev, Katy, TX (US)

(72) Inventor: Dmitri Dozortsev, Katy, TX (US)

(21) Appl. No.: 15/130,988

(22) Filed: Apr. 17, 2016

Related U.S. Application Data
(60) Provisional application No. 62/149,617, filed on Apr. 19, 2015.

(51) Int. Cl. B01L 9/06

(52) U.S. Cl. CPC B01L 9/06; B01L 2200/025; B01L 2200/087

(57) ABSTRACT

The non-vertical tube holder enables visual control for transferring a microscopic sample into the test-tube, decreasing the chance of the sample loss. The tube holder may also be used for a tube transportation to the sample testing facility.

### CROSS-REFERENCE TO RELATED APPLICATIONS

This application claims priority of United States Provisional Patent Application Ser. No. 62/149,617 filed on Apr. 19, 2015.

### FIELD OF INVENTION

The present invention in general relates to working with microscopic samples of cells in clinical or research laboratory.

### BACKGROUND OF THE INVENTION

Preimplantation embryo genetic testing is a process wherein a sample containing one or several cells is taken using an inverted microscope and micromanipulator and then tested to determine if the respective embryo is chromosomally (genetically) or metabolically normal.

After the sample is taken from an embryo it remains in the drop under oil until it is manually moved into the testing tube with a small amount of solution under control of a dissecting microscope.

This sample transfer represents a considerable challenge to the operator for two reasons. One is that holding a small tube with one hand, while a pipette with a sample in another hand limits operator's ability to focus a dissecting microscope on the sample.

Merely placing a sample onto the edge of a Petri dish solves this problem only partially, because the tube still can wiggle considerably.

Another problem is matching the tube and a sample numbers. Usually there are several samples from several biopsied embryos. It is critical that the sample would be placed into the corresponding tube number. However, the tube is usually too small to place a number on it in such way that it can be readily observed under the microscope without obstructing the view inside of the tube.

As a result, an operator has limited opportunity to verify that the right sample goes into the right tube leading to errors.

In fact, it has been reported that this type of errors is the leading cause of misdiagnosis in preimplantation genetics.

### SUMMARY OF THE INVENTION

According to the present invention, tube is held in the disclosed device at the angle facilitating the handling and improving the control needed in the process of transferring cells, including single cells.

The method includes placing a drop of media on the lower wall of the tube to enable visually control of the sample transfer into the tube to assure that it was successful.

Observing the number on the dish with the sample immediately prior observing the number on the holder which corresponds to the number of the tube assures that the tube will contain a correct sample. The holders may be stackable, which facilitates sample transportation to the testing laboratory.

### DETAILED DESCRIPTION OF THE INVENTION

The device holds the tube in a predictable position that frees an operator's hand to focus on the sample. Since the tube is placed at the angle, it makes it possible to place the drop of the solution on the lower wall of the tube, rather than on the bottom, so that it can be readily seen by an operator. The disclosed device can hold at least one tube.

Note that the drop placement of the lower wall of the tube creates another important distinction from the current process. Currently the small amount of the solution is added to all test tubes before they are placed into position to receive the sample. As a result, by the time the tube is placed in a position to receive a sample, the drop of the solution may be found anywhere in the tube and in most cases it slips to the bottom where sample cannot be observed during the subsequent transfer.

The method of the present invention provides for an optional placement of the drop into the tube, after it is already inserted into the holder in a position to receive the sample. This makes it possible to assure that the drop would be in an expected and convenient location by the time of the sample transfer.

The device has a large surface so that the number corresponding to the tube number can be placed on the device without obstructing the view within the tube.

Furthermore, this number can be readily verified under dissecting microscope by an operator during the transfer from the biopsy drop to the drop within the tube.

The device may also accommodate a label with a patient's name or another identifier.

Once the sample is transferred, it may remain in the device that can be used for transportation to the testing laboratory.

Several devices can be stocked on top of each other to make handling more convenient.

### DESCRIPTION OF THE DRAWINGS

FIG. 1a provides the top view of the disclosed device with an inserted test-tube (1) containing a drop of the solution on the lower wall (2) and FIG. 1b provides a separate view of the tube (1) and the drop of the solution (2). It must be appreciated that the device may be made of the clear material transparent to light.

FIG. 2 shows the top view of another preferred embodiment of the device, wherein the device holds more than 2 samples. It must be appreciated that the device may made of the clear material transparent to light.

FIG. 3 shows the device of FIG. 1a stacked on the top of other devices for storage and transportation. The angle of the tube can be appreciated. It must be appreciated that the device may be made of the clear material transparent to light.

FIG. 4 shows the device of device of FIG. 1a with the label. It must be appreciated that the device may be made of the clear material transparent to light.

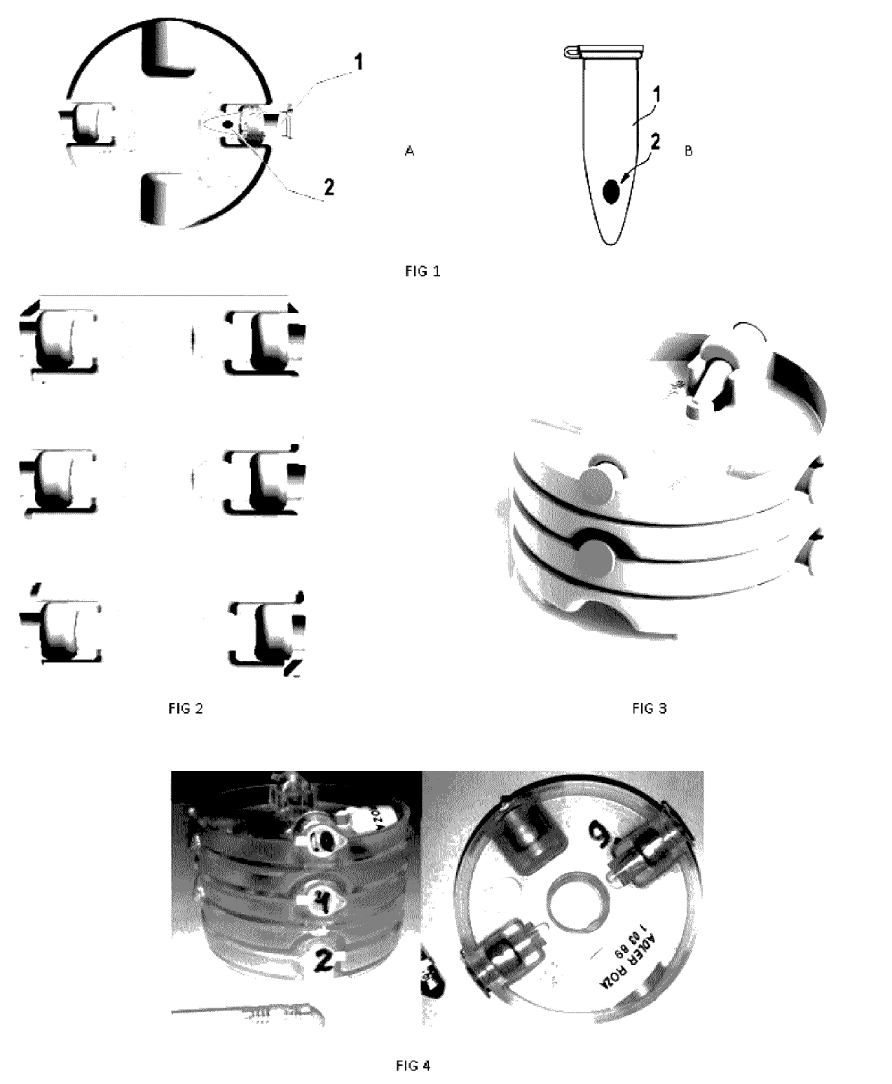

1. What claimed is a device that securely holds a tube at an angle over a transparent background, enabling an operator visual control for the placement of the specimen into a drop of the solution for a subsequent analysis.

2. A device of claim 1, wherein the said angle is other than 90 degrees.

3. A device of claim 1, wherein the device allows for adjusting the angle of the tube.

4. A device of claim 1, wherein the device holds one or more tubes

5. A device of claim 1, wherein the device is used to transport the sample

6. A device of claim 5, wherein the devices can be stocked on top of each other for transportation.

7. A device of claim 1, wherein the device is used to transfer a specimen after preimplantation embryo biopsy

8. A device of claim 1, wherein the tube is an Eppendorf type tube.

9. A device of claim 1, wherein the tube is a micro-centrifuge type tube.

10. A device of claim 1, wherein the tube is secured within the device in such way, that it can only be removed from the device by sliding it out to the side of the device along the tube's axis.

11. A device of claim 1, wherein the center of the device has an opening to enable faster cooling of the sample.

12. What claimed is a method of placing a sample into the tube, wherein the said tube is inserted into the device disclosed in claim 1 before a drop of a solution for the receiving sample is placed into the tube.

13. A method of claim 12, wherein a drop of a solution is placed on lower wall of the said tube.

14. What claimed is a method of claims 1, 7 and 12, wherein more than one sample is taken from the preimplantation embryo with each sample placed into separate tube for analysis and subsequent cross-validation.

15. A method of claim 1, wherein a number corresponding to the sample is placed on the disclosed device in such way that an operator can see it under the microscope.
